(19) United States
(12) Patent Application Publication
(10) Pub. No.: US 2008/0301283 A1
(43) Pub. Date: Dec. 4, 2008

(54) Website-controllable warning message broadcasting system

(76) Inventor: Tsung-Hsiang Lin, HuNei Hsiang (TW)

Correspondence Address: HOFFMANN & BARON, LLP, 6900 JERICHO TURNPIKE, SYOSSET, NY, 11791, US

(21) Appl. No.: 11/807,492

(22) Filed: May 29, 2007

(51) Int. Cl. G06F 15/173

(52) U.S. Cl. 709/224

(57) ABSTRACT

A website-controllable warning message broadcasting system includes a first network linking apparatus and a plurality of second network linking apparatus linked to one another via a central server. When a first alarm unit connected to the first network linking apparatus is triggered, users at the second network linking apparatus may use respective second display unit thereat to view images captured by a first image capture unit connected to the first network linking apparatus, and broadcast a warning to deter any invader or to help the user at the first network linking apparatus.

### FIELD OF THE INVENTION

The present invention relates to a website-controllable warning message broadcasting system, and more particularly to a website-controllable warning message broadcasting system that allows a plurality of related users to guard and help one another via image capture units linked to a central server.

### BACKGROUND OF THE INVENTION

Most of the currently available security systems are managed and controlled via a centralized control mechanism. When an alarm from a site is received, security guards are informed to move to the site to protect the life and property of any user thereat. Since such a centralized security system requires a relatively high cost, it is not affordable by most people.

Currently, there are security system and network camera that allow individual users to connect thereto via a network. However, such security system or network camera is usable only when a message can be transmitted between the security system or the network camera and the user. In the event the user is not linked to the network or the user disconnects his or her mobile phone, the security system or the network camera at the other end is not able to receive any message from the user or to check the user's current state. Therefore, the above-described security system and network camera have limited applicability and are not widely accepted for use.

It is therefore tried by the inventor to develop a website-controllable warning message broadcasting system, with which a group of related users, such as friends, families, and relatives, may be linked to one another via a central server, and when any one of the users needs help, other users may be informed by an alarm sent by that user and check the actual state of that user by viewing images captured by an image capture unit at that user in need of help.

### SUMMARY OF THE INVENTION

A primary object of the present invention is to provide a website-controllable warning message broadcasting system, so that a plurality of related users at different network linking apparatus are linked to one another via a central server, and when any one of the linked users is in need of help and triggers an alarm unit thereat, all other users may be informed to view on a display at respective network linking apparatus the images captured by an image capture unit provided at the user in need of help and broadcast a warning to deter an invader or call an ambulance for that user.

To achieve the above and other objects, the website-controllable warning message broadcasting system according to a preferred embodiment of the present invention includes a central server; a first network linking apparatus linked to the central server; a plurality of second network linking apparatus separately linked to the central server; a first image capture unit connected to the first network linking apparatus; a plurality of second image capture units separately connected to the plurality of second network linking apparatus; a first display unit connected to the first network linking apparatus; a plurality of second display units separately connected to the plurality of second network linking apparatus; a first alarm unit connected to the first network linking apparatus; and a plurality of second alarm units separately connected to the plurality of second network linking apparatus.

The first network linking apparatus and the plurality of second network linking apparatus are linked to one another via the central server. When the first alarm unit is triggered, users at the second network linking apparatus may use respective second display unit to view images captured by the first image capture unit.

With the first and the plurality of second network linking apparatus linked to one another via the central server, when the first alarm unit at the first network linking apparatus is triggered, users at the plurality of second network linking apparatus may use the second display units thereat to view images captured by the first image capture unit at the first network linking apparatus and broadcast a warning message, so as to achieve the purpose of deterring an invader or helping one another.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a systematic view of a website-controllable warning message broadcasting system according to a preferred embodiment of the present invention;

FIG. 2 shows a first example of use of the present invention; and

FIG. 3 shows a second example of use of the present invention.

### DETAILED DESCRIPTION OF THE PREFERRED EMBODIMENTS

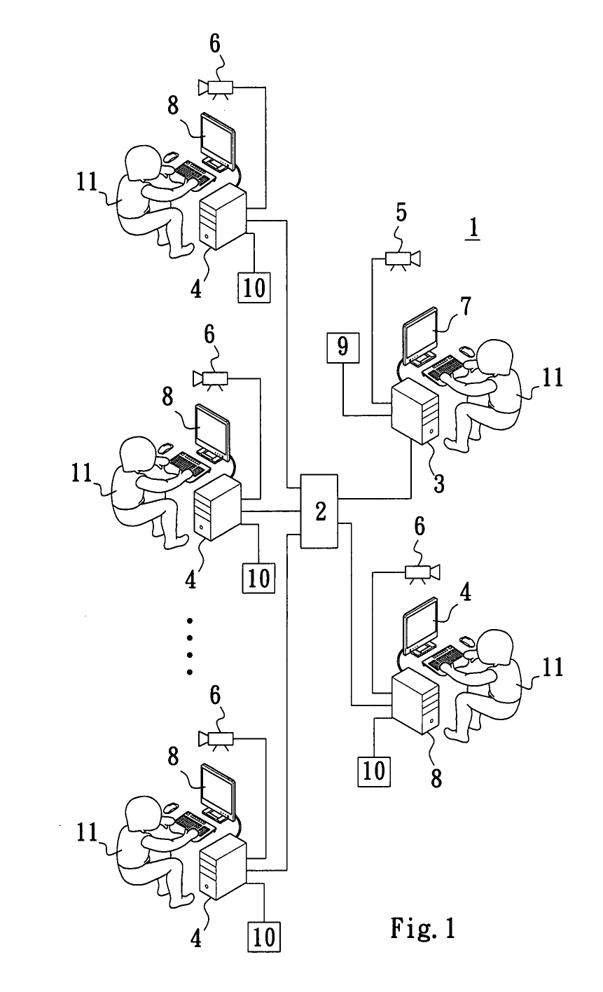

Please refer to FIG. 1 that is a systematic view of a website-controllable warning message broadcasting system 1 according to a preferred embodiment of the present invention. As shown, the website-controllable warning message broadcasting system 1 includes a central server 2; a first network linking apparatus 3, which may be a computer, a mobile phone, a personal digital assistant (PDA), or the like, being linked to the central server 2 via a wired or a wireless network; a plurality of second network linking apparatus 4, which may be computers, mobile phones, personal digital assistants (PDAs), or the like, being linked to the central server 2 via a wired or a wireless network; a first image capture unit 5, which may be a network camera, a digital video camera, or the like, being connected to the first network linking apparatus 3; a plurality of second image capture units 6, which may be network cameras, digital video cameras, or the like, being separately connected to the second network linking apparatus 4; a first display unit 7, which may be a computer screen, a mobile phone screen, or the like, being connected to the first network linking apparatus 3; a plurality of second display units 8, which may be computer screens, mobile phone screens, or the like, being separately connected to the second network linking apparatus 4; a first alarm unit 9, which may be a sensor or the like being connected to the first network linking apparatus 3; and a plurality of second alarm units 10, which may be sensors or the like being separately connected to the second network linking apparatus 4. When the users 11 of the first and the second network linking apparatus 3, 4 have logged in to and linked to the central server 2, the ways for contacting each of the users 11, such as via a mobile phone, a telephone, a Yahoo Messenger account, an email account, or a Skype account, are recorded in the central server 2, so that the users 11 may use the first or the second network linking apparatus 3, 4 to link to one another via the central server 2 and contact with one another via the recorded contacting ways.

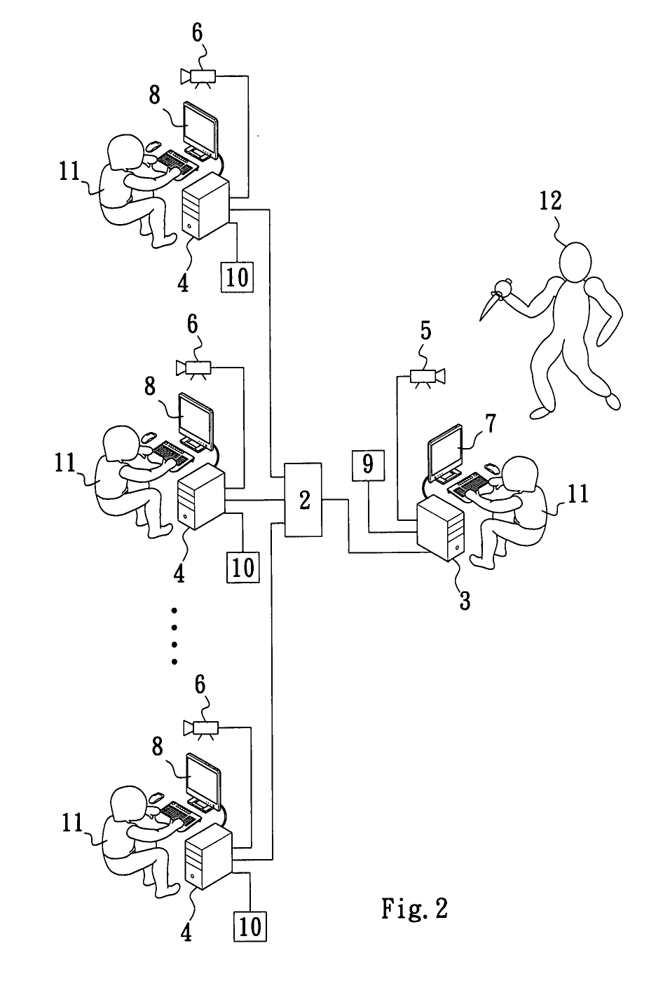

FIG. 2 shows a first example of use of the website-controllable warning message broadcasting system 1. Please refer to FIGS. 1 and 2 at the same time. When an invader 12 invades the place of a first user 11 and the first alarm unit 9 thereat is triggered, a warning message is sent by the first alarm unit 9 to the central server 2. On receipt of the warning message from the first alarm unit 9, the central server 2 forwards the same to the recorded contact persons in the recorded ways. When other users 11 recorded as the contact persons receive the warning message from the central server 2, they may immediately use the second display unit 8 connected to respective second network linking apparatus 4 to view images captured by the first image capture unit 5 provided at the first user's place and warn the invader 12 via broadcasting (not shown), so as to deter the invader 12.

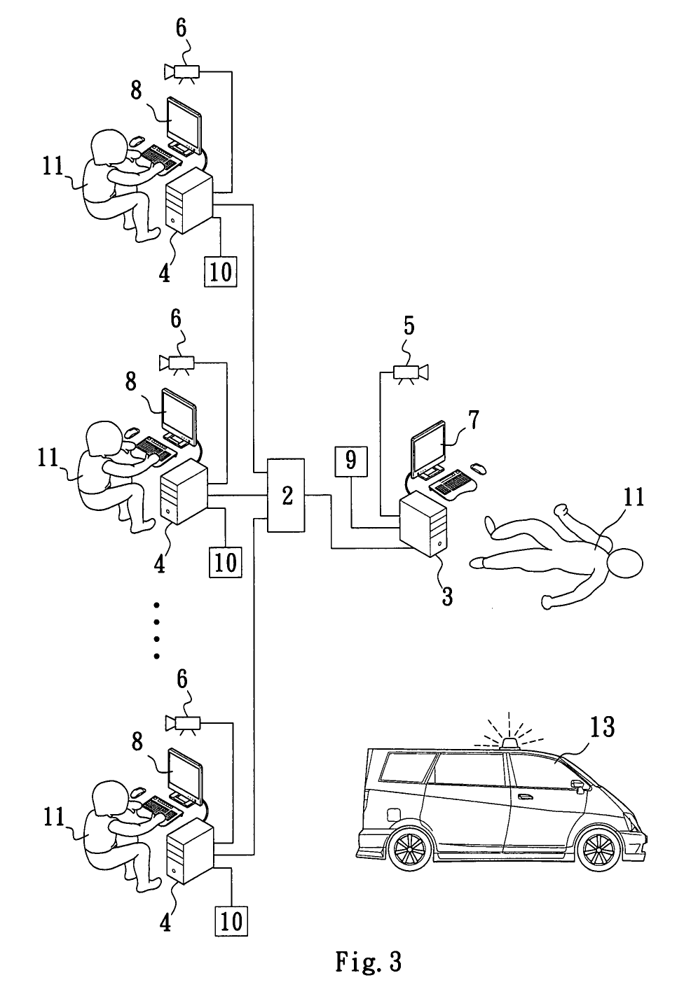

FIG. 3 shows a second example of use of the website-controllable warning message broadcasting system 1. Please refer to FIGS. 1 and 3 at the same time. When a first user 11 is sick and triggers the first alarm unit 9 provided at the first user's place, a message is sent by the first alarm unit 9 to the central server 2. On receipt of the message from the first alarm unit 9, the central server 2 forwards the same to the recorded contact persons in the recorded ways. When other users 11 recorded as the contact persons receive the message from the central server 2, they may immediately use the second display unit 8 connected to respective second network linking apparatus 4 to view images captured by the first image capture unit 5 provided at the first user's place and call an ambulance 13 to assist in the first user 11.

With the first and the plurality of second network linking apparatus 3, 4 linked to one another via the central server 2, when the first alarm unit 9 at the first network linking apparatus 3 is triggered, users 11 at the plurality of second network linking apparatus 4 may use the second display units 8 thereat to view images captured by the first image capture unit 5 at the first network linking apparatus 3 and broadcast a warning message, so as to achieve the purpose of deterring an invader and helping one another. The website-controllable warning message broadcasting system according to the present invention is therefore industrially valuable to meet the current market demands.

What is claimed is:

1. A website-controllable warning message broadcasting system, comprising:
a central server;
a first network linking apparatus being linked to the central server;
a plurality of second network linking apparatus being separately linked to the central server;
a first image capture unit being connected to the first network linking apparatus;
a plurality of second image capture units being separately connected to the plurality of second network linking apparatus;
a first display unit being connected to the first network linking apparatus;
a plurality of second display units being separately connected to the plurality of second network linking apparatus;
a first alarm unit being connected to the first network linking apparatus; and
a plurality of second alarm units being separately connected to the plurality of second network linking apparatus;
wherein the first network linking apparatus and the plurality of second network linking apparatus are linked to one another via the central server; and when the first alarm unit is triggered, users at the second network linking apparatus may use respective second display unit to view images captured by the first image capture unit.

2. The website-controllable warning message broadcasting system as claimed in claim 1, wherein the first network linking apparatus is linked to the central server via a wireless network.

3. The website-controllable warning message broadcasting system as claimed in claim 1, wherein the plurality of second network linking apparatus are linked to the central server via a wireless network.

4. The website-controllable warning message broadcasting system as claimed in claim 1, wherein the first network linking apparatus is linked to the central server via a wired network.

5. The website-controllable warning message broadcasting system as claimed in claim 1, wherein the plurality of second network linking apparatus are linked to the central server via a wired network.

6. The website-controllable warning message broadcasting system as claimed in claim 1, wherein the first network linking apparatus is selected from the group consisting of a computer, a mobile phone, and a PDA.

7. The website-controllable warning message broadcasting system as claimed in claim 1, wherein each of the plurality of second network linking apparatus is selected from the group consisting of a computer, a mobile phone, and a PDA.

8. The website-controllable warning message broadcasting system as claimed in claim 1, wherein the first image capture unit is selected from the group consisting of a network camera and a digital video camera.

9. The website-controllable warning message broadcasting system as claimed in claim 1, wherein each of the plurality of second image capture units is selected from the group consisting of a network camera and a digital video camera.

10. The website-controllable warning message broadcasting system as claimed in claim 1, wherein the first display unit is selected from the group consisting of a computer screen and a mobile phone screen.

11. The website-controllable warning message broadcasting system as claimed in claim 1, wherein each of the plurality of second display units is selected from the group consisting of a computer screen and a mobile phone screen.

12. The website-controllable warning message broadcasting system as claimed in claim 1, wherein the first alarm unit is a sensor.

13. The website-controllable warning message broadcasting system as claimed in claim 1, wherein each of the plurality of second alarm units is a sensor.
